(19) United States
(12) Patent Application Publication
(10) Pub. No.: US 2014/0238812 A1
(43) Pub. Date: Aug. 28, 2014

(54) DRIVE ASSEMBLY FOR AN AUTOMATIC TRANSMISSION INCLUDING A CLUTCH DAMPER

(71) Applicants: Schaeffler Group USA, Inc., Fort Mill, SC (US); Schaeffler Technologies GmbH & Co. KG, Herzogenaurach (DE)

(72) Inventor: Vural Ari, Lynnfield, MA (US)

(21) Appl. No.: 14/187,518

(22) Filed: Feb. 24, 2014

Related U.S. Application Data
(60) Provisional application No. 61/769,991, filed on Feb. 27, 2013.

(51) Int. Cl. F16D 3/12

(52) U.S. Cl. CPC F16D 3/12
USPC 192/30 V

(57) ABSTRACT

A drive assembly for an automatic transmission is provided. The drive assembly includes a clutch pack; and a damper assembly connected to the clutch pack, the damper assembly including a first spring set and a second spring set connected in series. The drive assembly may include an inner clutch carrier supporting the clutch pack and a first spring retainer connected to the inner clutch carrier and housing the first spring set. A method of forming a drive assembly for an automatic transmission is also provided.

This claims the benefit to U.S. Provisional Patent Application No. 61/769,991, filed on Feb. 27, 2013, which is hereby incorporated by reference herein.

The present disclosure relates generally to clutch dampers and more specifically to a clutch damper used in a drive assembly of an automatic transmission in a motor vehicle.

### BACKGROUND

U.S. Pat. No. 7,798,933 discloses a damper in a Lepelletier transmission.

U.S. Publication No. 2009/0253549 discloses a damper between a transmission brake and housing.

U.S. Pat. No. 4,422,535 discloses a damper assembly inside a torque converter.

### SUMMARY OF THE INVENTION

A drive assembly for an automatic transmission is provided. The drive assembly includes a clutch pack; and a damper assembly connected to the clutch pack, the damper assembly including a first spring set and a second spring set connected in series.

Embodiments of the drive assembly may also include one or more of the following advantageous features:

The drive assembly may include an inner clutch carrier supporting the clutch pack and a first spring retainer connected to the inner clutch carrier and housing the first spring set. The first spring retainer may be integral with or non-rotatably fixed to the inner clutch carrier. The drive assembly may include a spring retainer housing the second spring set, the spring retainer housing being rotatable with respect to the inner clutch carrier. The drive assembly may include a second spring retainer housing the second spring set. The second spring retainer may be rotatable with respect to the first spring retainer. The second spring retainer may include a spring set connecter connecting the first spring set and second spring set in series.

The first spring set and the second spring set may include a plurality of springs circumferentially spaced from each other.

The drive assembly may include a piston for engaging the clutch pack to transmit torque from an engine to the clutch pack. The clutch may transmit the torque through the first spring set to the second spring set. The second spring set may transmit the torque to a torque output component. The torque output component may be coupled to a planetary gear train.

A method of forming a drive assembly for an automatic transmission is also provided. The method includes connecting a first spring set and a second spring set in series and connecting the first spring set to an inner radial surface of a clutch pack.

Embodiments of the method may also include one or more of the following advantageous features:

The method may include connecting the second spring set to a torque output component. The first spring set and the second spring set maybe connected by a connector extending axially between the first spring set and the second spring set. The connecting of the first set to the inner radial surface of the clutch pack may include directly connecting a retainer of the first spring set to an inner carrier of the clutch pack. The connecting of the first spring set and the second spring set in series may include connecting a first retainer housing the first spring set to a second retainer housing the second spring set. The second retainer may be rotatable with respect to the clutch pack.

### BRIEF DESCRIPTION OF THE DRAWINGS

The present invention is described below by reference to the following drawings, in which:

FIG. 1 schematically shows a cross-sectional view of a drive assembly for an automatic transmission according to an exemplary embodiment of the present invention;

FIG. 2 shows a plan view of a first arc spring set of the drive assembly shown in FIG. 1;

FIG. 3a shows a plurality of an exploded view of a drive unit of a drive assembly in accordance with another embodiment of the present invention;

FIG. 3b shows a cut away perspective view of an inside of a damper assembly of the drive unit shown in FIG. 3a;

FIG. 3c shows a cut away perspective view of an inside of the drive unit shown in FIG. 3a;

FIG. 3d shows a cut away side view of the drive unit shown in FIG. 3a; and

FIG. 3e shows perspective view of the drive unit shown in FIG. 3a.

### DETAILED DESCRIPTION

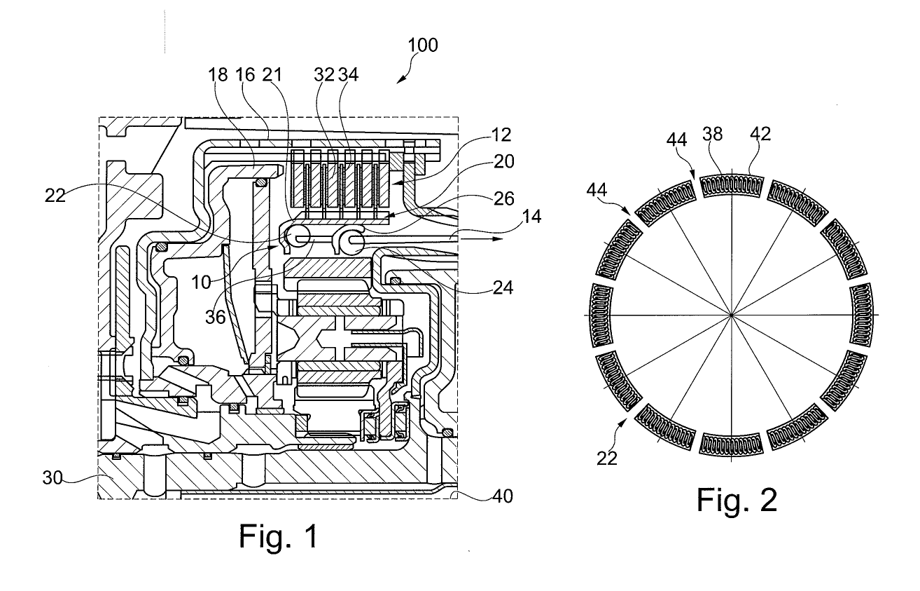

FIG. 1 schematically shows a cross-sectional view of a drive assembly 100 for an automatic transmission according to an exemplary embodiment of the present invention. Drive assembly 100 may be a drive assembly of planetary automatic transmission in a motor vehicle and has an axis 40. Drive assembly 100 includes a torsional vibration damper assembly 10 disposed between a transmission clutch pack 12 and a torque output component 14, which may be coupled to a planetary gear train. Input torque from an engine is transferred to outer clutch carrier 16, via an input shaft 30. When a clutch piston 18 engages clutch pack 12, torque is transmitted from outer clutch carrier through clutch pack 12 to an inner clutch carrier 20.

A radially outer portion of clutch pack 12 is supported by outer clutch carrier 16 and a radially inner portion of clutch pack 12 is supported by inner clutch carrier 20. Clutch pack 12 may include a plurality of annular clutch plates 32 and a plurality of annular friction material plates 34 interleaved between clutch plates 32. In this embodiment, clutch plates 32 are supported by outer clutch carrier 16 and friction material plates 34 are supported by inner clutch carrier 20, although different arrangements may be employed.

In this embodiment, inner clutch carrier 20 serves as a first spring retainer 21 as well, which houses a first set of arc springs 22. In an alternative embodiment, instead of inner clutch carrier 20 being integral with the first spring retainer 21, the inner clutch carrier and first spring retainer 21 may be non-rotatably fixed together. A second arc spring set 24 is disposed in series to first arc spring set 22. A second spring retainer 26, which is rotatable relative to inner clutch carrier 20, establishes a connection between the first and second arc spring sets 22, 24. Damper assembly 10 accordingly includes two spring retainer segments 20, 26 arranged in series, and two, axially offset spring sets 22, 24. Second spring retainer 26 includes at least one spring set connector 36 and transmits torque downstream in the transmission to torque output component 14.

A radially outer portion of inner clutch carrier 20 supports clutch pack 12, while a radially inner portion of inner clutch carrier 20 supports damper assembly 10. Second spring retainer 26 is positioned radially inside of inner clutch carrier 20 and connects first spring set 22 to second spring set 24. In the embodiment shown in FIG. 1, the at least one spring set connector 36 thereof is configured as a tab extending axially away from second spring set 24 and axially between two of the springs of first spring set 22. A first axial portion of torque output component 14 extends axially between two of the springs of second spring set 24 and a second axial portion of torque output component 14 extends axially away from damper assembly 10 toward downstream components of drive assembly 100.

Respective first and second spring sets 22 and 24 each include a plurality of individual arc springs. Connectors 36 and 14 extend between respective pairs of the plurality of springs from sets 22 and 24. Interspaced circumferential gaps between the individual springs, such as gaps 44 shown in FIG. 2, receive the connectors. Similarly, retainers 21 and 26 include spring drive tabs extending into the circumferential gaps between the pairs of spring sets. In an example embodiment, the drive tabs may be radially crimped portions of the retainer as is known in the art. Torque from inner carrier 20 passes through the drive tabs in first retainer 21 to an arc spring of first set 22, through connector 36 and the drive tab of retainer 26 to a spring of set 24, to output component 14. Torque in the opposite direction (i.e., from component 14 to carrier 20) is transmitted through the springs from the connectors to the drive tabs.

FIG. 2 shows a plan view of a portion of first arc spring set 22. In this embodiment shown in FIG. 2, first arc spring set 22 includes twelve arc springs 38 spaced in the circumferential direction from each other. Each arc spring 38 is housed in a respective window 40 formed in the first spring retainer 21. In other embodiments, first arc spring set 22 may include more or less than twelve springs. Second arc spring set 24 may be formed in a similar manner as first arc spring set 22, with a plurality of springs spaced in the circumferential direction from each other and housed in respective windows of second spring retainer 26.

Drivetrain noise, vibration and harshness (“NVH”) is mitigated through damper assembly 10 and finally transferred to torque output component 14. Having two arc spring sets 22, 24 enables a lower damper rate, thus, better NVH performance. For example, by installing the spring sets in a series configuration as shown in FIG. 1, a resulting rate of the damper assembly is approximately half that of an individual spring set. Damper assembly 10 may provide minimum tear-up on the customer side by packing damper assembly within an existing envelope. Damper assembly 10 may fit into a drive assembly of an automatic transmission and may help isolate the drive assembly's NVH. Drive assembly 100 may advantageously provide better NVH isolation by having damper assembly 10 within the transmission assembly close to the clutch elements and/or torque output elements.

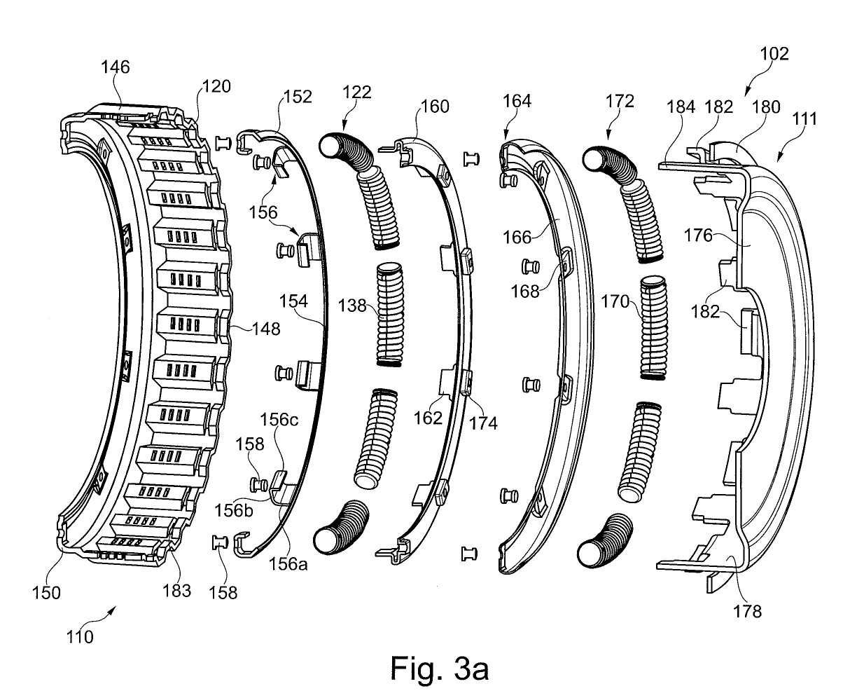

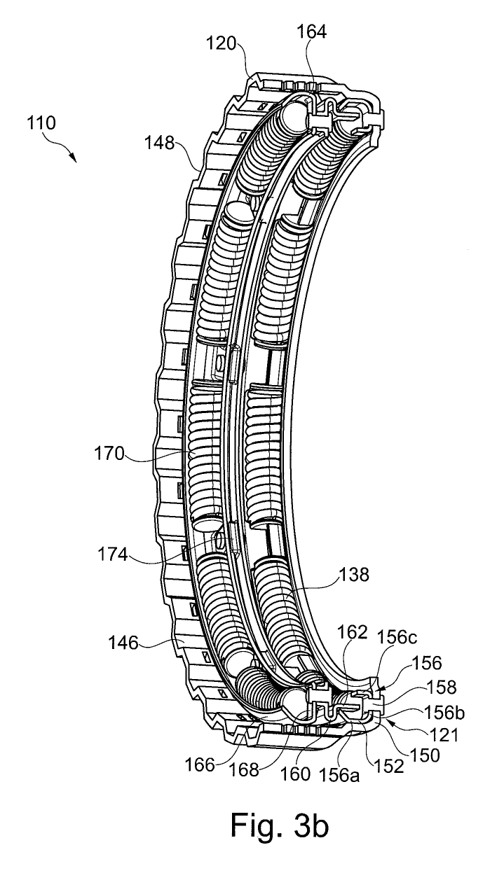

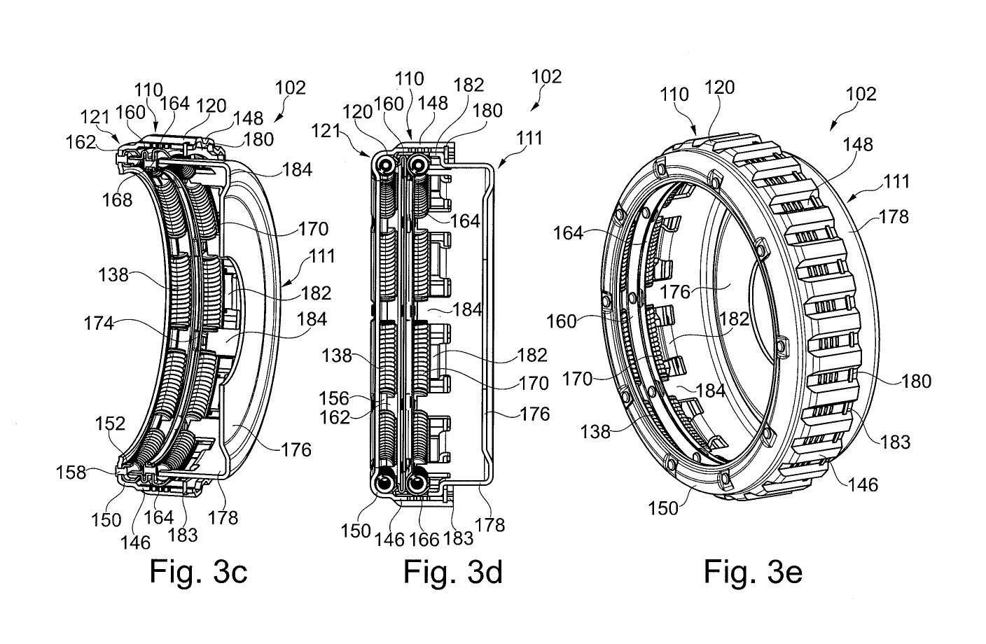

FIGS. 3a to 3e show a plurality of detailed views of a drive unit 102, which includes a damper assembly 110 and a torque output component in the form of a transmission drive plate 111, of a drive assembly in accordance with an embodiment of the present invention. Damper assembly 110 and transmission drive plate 111 may be used in drive assembly 100 in FIG. 1 in place of damper assembly 10 and torque output component 14. FIG. 3a shows an exploded view of drive unit 102. FIG. 3b shows a cut away perspective view of an inside of damper assembly 110. FIG. 3c shows a cut away perspective view of an inside of drive unit 102. FIG. 3d shows a cut away side view of an inside of drive unit 102. FIG. 3e shows perspective view of drive unit 102.

Damper assembly 110 includes a clutch carrier 120 having an axially extending cylindrical portion 146 including axially extending grooves 148 formed in the outer surface thereof for supporting friction material plates 34 (FIG. 1) and a retaining portion 150 for forming a first spring retainer 121 with a retaining ring 152. Retaining portion 150 is substantially arc shaped and extends axially from one axial end of axial extension 146 and then radially inward. Retaining ring 152 includes an outer ring section 154 and a plurality of circumferentially spaced abutment portions 156 that abut the circumferential edges of arc springs 138 of first arc spring set 122 and limit the circumferential movement of arc springs 138. Abutment portions 156 are fixed to retaining portion 150 radially inside of axial extension 146 by a plurality of rivets 158. Specifically, each of abutment portions 156 is substantially C-shaped when viewed in cross-section and includes a first axial flange 156a connected to and extending axially away from outer ring section 154, a radial flange 156b connected to and extending radially inward from axial flange 156a and a second axial flange 156c connected to and extending axially away from radial flange 156b.

Damper assembly 110 includes a ring shaped drive plate 160 provided adjacent to retaining ring 152 such that retaining ring 152 is positioned axially between drive plate 160 and retaining portion 150. Drive plate 160 includes a plurality of axially extending drive tabs 162 that are circumferentially spaced from each other and extend axially from a base ring 162 in between arc springs 138 so drive tabs 162 abut the circumferential edge of arc springs 138 and are in circumferential driving engagement with arc springs 138. Each of drive tabs 162 extends axially into a respective abutment portion 156 such that each drive tab 162 is radially between axial flanges 156a, 156c.

Damper assembly 110 also includes a ring shaped second spring retainer 164 provided adjacent to drive plate 160 such that drive plate 160 is positioned between spring retainer 164 and retaining ring 152. Spring retainer 164 is substantially formed of segments 166, which when viewed in cross-section are arc shaped, that are interrupted by circumferentially spaced abutment portions 168 that abut the circumferential edges of arc springs 170 of a second arc spring set 172 and limit the circumferential movement of arc springs 170. Abutment portions 168 are fixed to seats 174 on base ring 162 of drive plate 160 by a plurality of rivets 158.

Transmission drive plate 111 is substantially cup-shaped and includes a radially extending plate portion 176 and an axially extending cylindrical portion 178. Transmission drive plate 111 is fixed to clutch carrier 120 by a snap ring 180. At the end of cylindrical portion 178, drive plate 111 includes a plurality of connecting tabs 182 that are fixed inside of clutch carrier 120 by snap ring 180. The connection between clutch carrier 120, snap ring 180 and drive plate 111 allows drive plate 111 to hold springs 138, drive plate 160, spring retainer 164 and springs 170 axially in place inside of clutch carrier 120. Snap ring 180 is positioned in radially extending slots 183 formed in cylindrical portion 146 of clutch carrier 120. Connecting tabs 182 are spaced circumferentially from each other and transmission drive plate 111 further includes a plurality of axially extending drive tabs 184 circumferentially from each other, with each drive tab 184 being between two connecting tabs 182. Drive tabs 184 extend axially from cylindrical portion 178 in between arc springs 170 so drive tabs 184 abut the circumferential edge of arc springs 170 and are in circumferential driving engagement with arc springs 170. Each of drive tabs 162 extends axially into a respective abutment portion 156 such that each drive tab 162 is radially between axial flanges 156a, 156c.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A drive assembly for an automatic transmission comprising:
a clutch pack; and
a damper assembly connected to the clutch pack, the damper assembly including a first spring set and a second spring set connected in series.

2. The drive assembly as recited in claim 1 further comprising an inner clutch carrier supporting the clutch pack.

3. The drive assembly as recited in claim 2 further comprising a first spring retainer housing the first spring set, the first spring retainer being connected to the inner clutch carrier.

4. The drive assembly as recited in claim 3 wherein the first spring retainer is integral with or non-rotatably fixed to the inner clutch carrier.

5. The drive assembly as recited in claim 4 further comprising a second spring retainer housing the second spring set, the second spring retainer being rotatable with respect to the first spring retainer.

6. The drive assembly as recited in claim 5 wherein the second spring retainer includes a spring set connecter connecting the first spring set and second spring set in series.

7. The drive assembly as recited in claim 1 wherein the first spring set includes a plurality of springs circumferentially spaced from each other.

8. The drive assembly as recited in claim 1 wherein the second spring set includes a plurality of springs circumferentially spaced from each other.

9. The drive assembly as recited in claim 1 further comprising a spring retainer housing the second spring set.

10. The drive assembly as recited in claim 9 wherein the spring retainer includes a spring set connecter connecting the first spring set and second spring set in series.

11. The drive assembly as recited in claim 10 wherein the spring set connector extends axially with respect to an axis of the drive assembly into at least one spring of the second spring set.

12. The drive assembly as recited in claim 1 further comprising a piston for engaging the clutch pack to transmit torque from an engine to the clutch pack.

13. The drive assembly as recited in claim 12 wherein the clutch transmits the torque through the first spring set to the second spring set.

14. The drive assembly as recited in claim 13 wherein the second spring set transmits the torque to a torque output component.

15. The drive assembly as recited in claim 14 wherein the torque output component is coupled to a planetary gear train.

16. A method of forming a drive assembly for an automatic transmission comprising:
connecting a first spring set and a second spring set in series; and
connecting the first spring set to an inner radial surface of a clutch pack.

17. The method as recited in claim 16 further comprising connecting the second spring set to a torque output component.

18. The method as recited in claim 16 wherein the first spring set and the second spring set are connected by a connector extending axially between the first spring set and the second spring set.

19. The method as recited in claim 16 wherein the connecting of the first set to the inner radial surface of the clutch pack includes directly connecting a retainer housing the first spring set to an inner carrier of the clutch pack.

20. The method as recited in claim 16 wherein the connecting of the first spring set and the second spring set in series includes connecting a first retainer housing the first spring set and to a second retainer housing the second spring set, the second retainer being rotatable with respect to the clutch pack.
